(19) United States
(12) Patent Application Publication
(10) Pub. No.: US 2024/0353381 A1
(43) Pub. Date: Oct. 24, 2024

(54) MULTI-CORRECTION ANALYSIS METHOD USING CHROMATOGRAPH

(71) Applicants: SHIMADZU CORPORATION, Kyoto (JP); Hyogo College of Medicine, Hyogo (JP)

(72) Inventors: Tomonori YOKOYAMA, Kyoto-shi, Kyoto (JP); Noriyuki OJIMA, Kyoto-shi, Kyoto (JP); Reiko TANAKA, Kyoto-shi, Kyoto (JP); Shin NISHIUMI, Akashi-shi, Hyogo (JP)

(73) Assignees: SHIMADZU CORPORATION, Kyoto (JP); Hyogo College of Medicine, Hyogo (JP)

(21) Appl. No.: 18/685,442

(22) PCT Filed: Aug. 23, 2021
(86) PCT No.: PCT/JP2021/030849

§ 371 Date: Feb. 21, 2024

(51) Int. Cl. G01N 30/86; G01N 30/06; G01N 30/72

(52) U.S. Cl. CPC G01N 30/86; G01N 30/06; G01N 30/7206

(57) ABSTRACT

A multi-correction analysis method for correcting a result of analyzing a large number of object substances contained in a sample using a chromatograph, includes: grouping at least a part of a large number of object substances possibly contained in a sample to be analyzed into groups based on changes in the measured values of the part of the object substances obtained by performing chromatographic analysis of the sample under different analysis conditions, and determining a surrogate substance for each of the groups; and adding the surrogate substance to the sample as an internal standard substance common to the object substances contained in each group, and correcting a measured value of each of the large number of object substances obtained from a result of chromatographic analysis of the sample with a measured value of the internal standard substance corresponding to the group to which the object substance belongs.

### TECHNICAL FIELD

The present invention relates to a multi-correction analysis method using a chromatograph.

### BACKGROUND ART

When a measured value of a compound in a sample is corrected using a chromatograph such as a gas chromatograph (GC) or a liquid chromatograph (LC), a measured value of a standard substance not contained in the sample is generally used. There are methods such as an external standard method in which a sample containing a standard substance is measured in advance separately from the sample, and an internal standard method in which an internal standard substance is added to the sample.

In the external standard method, a standard sample containing a standard substance is prepared separately from an unknown sample, and the standard sample is measured. Then, an area value of the peak derived from the object substance appearing in the chromatogram obtained by measuring the unknown sample is obtained, and a ratio of the area value to an area value of the standard substance is calculated. By using the ratio of the area values, it is possible to compare amount ratios of the object substance between samples. The external standard method allows for a highly accurate correction as long as there is no influence of foreign substances or other factors. On the other hand, it is necessary to prepare a standard sample for each object substance.

On the other hand, in the internal standard method, an internal standard substance which is separable from the object substance by a chromatograph (and also separable in mass-to-charge ratio if a mass spectrometer is used as a detector) and has a retention time as close to the object substance as possible is added to an unknown sample, and the unknown sample is measured. The area values of the peak derived from the internal standard substance and the peak derived from the object substance are obtained from the chromatogram created based on the measured data, and its ratio (peak area ratio) is obtained. According to the internal standard method, it is possible to avoid measurement errors due to various factors, such as the variation in the amount of sample injected into the chromatograph or the vaporization of the sample solvent.

In the inspection of residual agricultural chemicals or environmental pollutants, or in the screening of toxicants, peak area ratios of several tens to several hundreds of compounds are obtained in one-time analysis, and quantification is performed using a calibration curve prepared in advance. For such a simultaneous multicomponent analysis, not only temporal component separation by a chromatograph but also component separation according to a mass-to-charge ratio using a gas chromatograph mass spectrometer (GC/MS) or a liquid chromatograph mass spectrometer (LC/MS) is used. In the case of simultaneous multicomponent analysis, it is practically impossible to prepare a standard substance for each object substance from the viewpoint of cost and analysis efficiency. Therefore, conventionally and generally, an operation is performed in which a plurality of object substances having close retention times are grouped, and for each group, an appropriate compound, or more specifically, a physically and chemically stable compound which is as close as possible to the object substance belonging to each group in terms of retention time, is assigned as an internal standard substance, and correction is performed by the internal standard method using the internal standard substance.

Another factor to be considered is that certain kinds of object substances are easily desorbed or decomposed during the analysis; for example, such a situation can occur in a GC/MS depending on the condition of the injection-port insert provided at the inlet of the column, the column, the ion source or other devices. When such adsorption or decomposition fluctuates due to differences in physical and chemical properties between the object substance and the internal standard substance, it is often the case that the internal standard method using these internal standard substances cannot correct variations in the area value due to such factors. In addition to the factors that depend on the state of the device as described above, a pretreatment operation such as extraction, purification, concentration, or constant volume of the object substance from the sample may lose a part of the object substance, which may also cause a variation in the area value.

As a method for correcting the variation in the area value due to the various factors and pretreatment operations described above, a surrogate method has conventionally been used. In the surrogate method, a substance having similar physical properties to the object substance is selected as a surrogate substance, a certain amount of surrogate substance is added to a sample before a pretreatment operation to perform the pretreatment operation, and the area value is corrected assuming that variation in the recovery rate of the obtained surrogate substance and the object substance due to the pretreatment operation is the same (see Patent Literature 1 for example). The surrogate substance should preferably be a compound which is separable from the object substance and is as similar in physical properties to the object substance as possible, and in general, a compound which is structurally the same as the object substance and is labeled by a stable isotope (usually, a stable isotope of carbon 13 (¹³C)) is used.

In general, by adding the internal standard substance described above before the pretreatment operation, it is possible to perform correction with high accuracy compensating for the loss of the compound at the stage of the pretreatment operation. However, also in a case where the correction is performed using the surrogate substance as an internal standard substance, it is difficult to prepare the surrogate substance for each object substance, similarly to the correction by the internal standard method described above. In particular, in simultaneous multicomponent analysis in which the number of object substances exceeds several hundred, it is not realistic to individually prepare a surrogate substance for each of all object substances.

Therefore, a method has been proposed in which object substances are grouped using at least one of an elution position when silica gel column chromatography is performed under the same conditions for all the object substances contained in a sample or a result of measuring a distribution rate in a hexane-acetonitrile distribution method, and different surrogate substances are selected for respective groups (Patent Literature 2).

### CITATION LIST

### Patent Literature

Patent Literature 1: JP 2003-342291 A (Paragraph[0003])

Patent Literature 2: WO 2015/064530 A

### NON PATENT LITERATURE

Non Patent Literature 1: Oncotarget 2017 8(10), pp. 17115-17126

### SUMMARY OF INVENTION

### Technical Problem

In the method of Patent Literature 2, object substances are grouped on the basis of similarities and differences in chemical and physical properties such as polarity, volatility, and degradability. Therefore, for example, when a large number of compounds having various chemical properties and physical properties, such as residual agricultural chemicals and environmental pollutants in food, are quantitatively analyzed, the object substances can be appropriately grouped by using the method described in Patent Literature 2.

On the other hand, in the analysis of metabolites in a biological sample performed for the purpose of elucidating the cause of a specific disease, searching for a marker substance of a disease, drug discovery screening, and the like (Non Patent Literature 1), since many chemical properties and physical properties of object substances are similar, it is difficult to appropriately group the object substances by the method described in Patent Literature 2. In particular, when a metabolite in a biological sample is analyzed using GC/MS, a reagent for derivatizing the metabolite is added to the sample at the stage of a pretreatment operation in order to promote ionization of the metabolite. By being derivatized, chemical and physical properties of metabolites become more similar to each other, and therefore grouping becomes more difficult.

An object of the present invention is to enable correction in consideration of an influence of loss of an object substance at a stage of pretreatment operation or during analysis even without preparing an internal standard substance or a surrogate substance individually corresponding to all object substances, when a large number of object substances having similar chemical properties and physical properties are measured by one-time analysis using a chromatograph.

### Solution to Problem

The present invention made to solve the above problems is [symbol] [symbol] a multi-correction analysis method for correcting a result of analyzing a large number of compounds contained in a sample using a chromatograph, the method including: grouping at least a part of a large number of object substances which are possibly contained in a sample to be analyzed into a plurality of groups based on changes in the measured values of the part of the object substances obtained by performing chromatographic analysis of the sample a plurality of times under different analysis conditions, and determining a surrogate substance for each of the plurality of groups; and adding the surrogate substance to the sample as an internal standard substance common to the object substances contained in each group, and correcting a measured value of each of the large number of object substances obtained from a result of chromatographic analysis of the sample with a measured value of the internal standard substance corresponding to the group to which the object substance belongs.

### Advantageous Effects of Invention

According to the present invention, when a large number of object substances having similar chemical properties and physical properties are measured by one-time analysis using a chromatograph, it is possible to perform correction in consideration of an influence of loss of an object substance at a stage of pretreatment operation or during analysis without preparing an internal standard substance or a surrogate substance individually corresponding to all object substances.

### BRIEF DESCRIPTION OF DRAWINGS

FIG. 1 is a schematic device configuration diagram of a GC/MS which implements a correction analysis method according to the present invention.

FIG. 2 is a diagram illustrating, when a sample to be analyzed is a plasma sample, a relationship between a flow of processing from pretreatment to GC/MS analysis and a factor that affects detection sensitivity of a metabolic component contained in the sample.

FIG. 3 is a graph showing a relationship between the amount ratio of a derivatization reagent to a sample and the change rate of the measured value of each metabolite contained in the sample (upper row), and a table showing a dispensed amount of the sample and the derivatization reagent at each amount ratio (lower row).

FIG. 4 is a graph showing a relationship between a reaction time for derivatization and a change rate in an area value of each metabolite contained in a sample.

### DESCRIPTION OF EMBODIMENTS

A correction analysis method according to the present invention is hereinafter described in detail with reference to the attached drawings.

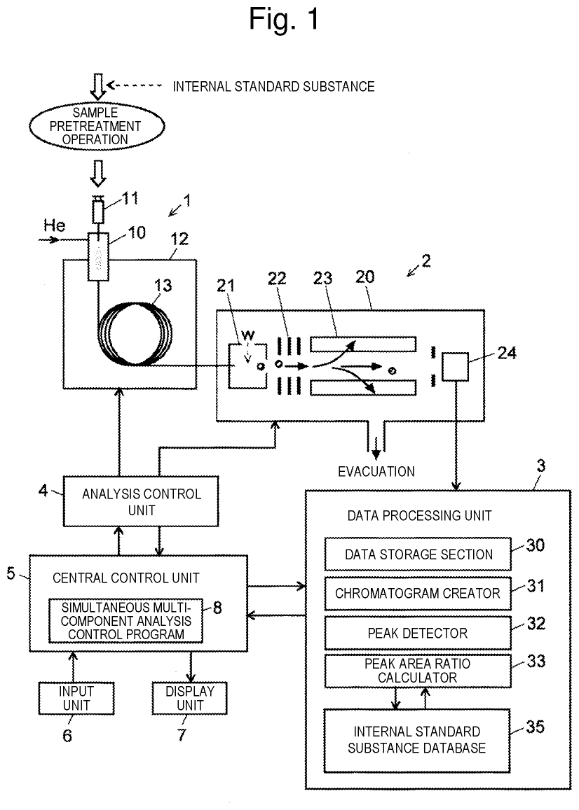

FIG. 1 is a schematic configuration diagram of one example of a GC/MS which implements the correction analysis method.

This GC/MS includes a gas chromatograph (GC) 1, mass spectrometer 2, data processing unit 3, analysis control unit 4, central control unit 5, input unit 6, and display unit 7. The GC 1 includes a sample vaporization chamber 10 for vaporizing a small amount of liquid sample, a micro-syringe 11 for injecting the liquid sample into the sample vaporization chamber 10, a column 13 for temporally separating the components of the sample, and a column oven 12 for controlling the temperature of the column 13. The mass spectrometer 2 includes an analysis chamber 20 evacuated by a vacuum pump (not shown). This chamber contains an ion source 21 for ionizing compounds to be analyzed by an appropriate ionization method (e.g. electron ionization), an ion lens 22 for transporting ions while converging them, a quadrupole mass filter 23 composed of four rod electrodes, and a detector 24 for producing, as the detection signal, an ion strength signal corresponding to the amount of incoming ions.

The data processing unit 3 to which the ionic intensity data is input by the detector 24 includes, as functional blocks, a data storage section 30, a chromatogram creator 31, a peak detector 32, a peak area ratio calculator 33, and an internal standard substance database 35, and correct area values of a large number of object substances contained in a sample. In the present example, this area value (area value of a peak derived from the object substance in the chromatogram) corresponds to the measured value of the object substance. The same applies to the measured value of the internal standard substance. Note that not limited to the area value of the peak, the height value of the peak may be used as the “measured value”.

The analysis control unit 4 has the function of controlling the operations of the GC 1 and the mass spectrometer 2 under the command of the central control unit 5. The central control unit 5 is responsible for the general control of the entire system in addition to the user interface through the input unit 6 and display unit 7. The central control unit 5 includes a storage device, which holds a simultaneous multicomponent analysis control program 8 for carrying out a characteristic control for a simultaneous multicomponent analysis. and the CPU or the like controls each unit via the analysis control unit 4 according to this program 8, thus simultaneously analyzing many object substances included in a sample, and performing measurements and data processing necessary for correcting a result (area value) obtained in the analysis.

The central control unit 5 and the data processing unit 3 can be configured, for example, on a personal computer prepared as a hardware resource, with their respective functions realized by running, on this computer, a dedicated controlling and processing software program previously installed on the same computer. In this case, the input unit 6 includes a keyboard and pointing device (e.g. mouse) annexed to the computer. The display unit 7 is the display monitor of the computer.

Next, a basic GC/MS analysis operation in the GC/MS illustrated in FIG. 1 will be schematically described.

When a small amount of liquid sample is dropped from the micro-syringe 11 into the sample vaporization chamber 10, the liquid sample quickly vaporizes within the sample vaporization chamber 10. Various kinds of substances in the sample are carried by the carrier gas (e.g. helium) into the column 13. While the sample is passing through the column 13. the substances in the sample are individually delayed by different amounts of time and reach the exit port of the column 13. The column oven 12 is controlled so as to maintain the temperature at an almost fixed level or increase the temperature according to a predetermined temperature profile. The ion source 21 in the mass spectrometer 2 sequentially ionizes the substances in the gas supplied from the exit port of the column 13.

The analysis control unit 4 applies, to each rod electrode of the quadrupole mass filter 23, a specific form of voltage which allows the passage of an ion having a specific mass-to-charge ratio. Therefore, among the various ions originating from the compounds introduced into the ion source 21, only an ion having a specific mass-to-charge ratio is allowed to pass through the quadrupole mass filter 23 and reach the detector 24, which sends a signal corresponding to the amount of ion to the data processing unit 3. In the present case, the kinds of object substances are previously known (although it is unknown whether or not they are actually contained in the sample). For example, in an analysis performed to search for a marker substance for determining whether or not a subject suffers from a specific disease, a known metabolite contained in a biological sample such as blood is an object substance. Accordingly, the mass-to-charge ratios of the ions to be detected originating from the object substances are previously known, and the retention times for those object substances are also previously known. Therefore, it is possible to completely detect the ions originating from the object substances by conducting the selected ion monitoring (SIM) measurement in the mass spectrometer 2 with the range of the measurement time defined in the vicinity of the retention time for each object substance and the monitored mass-to-charge ratio set at the value corresponding to the object substance.

To simultaneously analyze and measure object substances contained in an unknown sample in GC/MS, it is necessary to previously construct an internal standard substance database for performing correction by an internal standard method. In the present embodiment. a large number of object substances possibly contained in an unknown sample are divided into a plurality of groups, a surrogate substance is selected for each group, and correction is performed by an internal standard method using the surrogate substance as an internal standard substance. Hereinafter, a method for selecting a surrogate substance (internal standard substance) will be described.

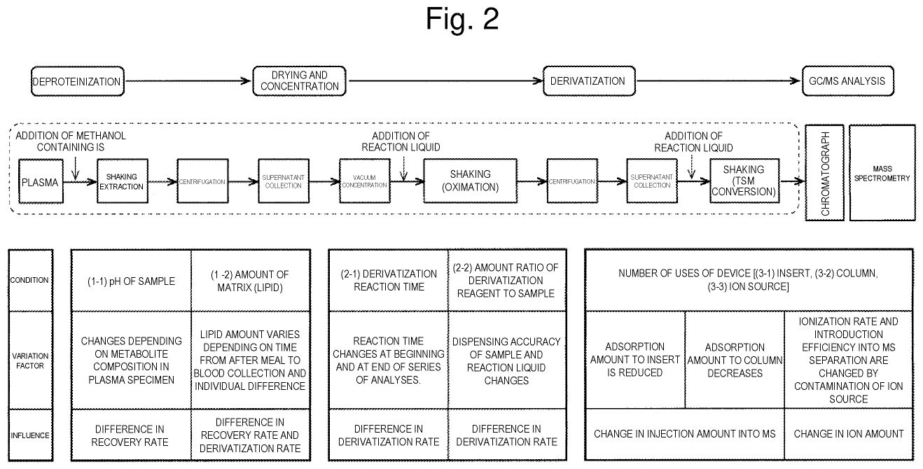

FIG. 2 illustrates a general flow of an operation from pretreatment of a sample to introduction of the sample into GC/MS, in a case of analyzing various kinds of metabolites in a biological sample (plasma) by GC/MS. As shown in the upper row of FIG. 2, the pretreatment includes deproteinization treatment, drying concentration treatment, and derivatization treatment.

The deproteinization treatment includes a treatment in which methanol is added to plasma collected from a subject, shaken and extracted, then centrifuged, and its superatant is collected. Methanol added to plasma contains an internal standard substance in advance.

The sample obtained by the deproteinization treatment (deproteinized sample) is subsequently subjected to vacuum concentration treatment, and then subjected to a treatment for derivatizing metabolites. FIG. 2 shows an example in which two types of derivatization treatments, oximation and silylation, are performed as derivatization. First, an oximation reagent is added to the deproteinized sample concentrated in vacuo and shaken to react the metabolite with the oximation reagent. This gives a sample in which the metabolite is oximated (oximation sample). Furthermore, the oximation sample is centrifuged to collect a supernatant. A silylation reagent is added to the supernatant, and the mixture is shaken to react the metabolite with the silylation reagent. This gives a sample in which the metabolite is oximated and silylated (derivatized sample). The derivatized sample thus obtained is injected to GC/MS and subjected to GC/MS analysis. Examples of the oximation reagent include pentafluorobenzyl and hydroxylamine hydrochloride, and examples of the silylation reagent include a trimethylsilylation agent (BSTFA. MSTFA, TMSI-H).

The following (1) to (6) are mentioned as main factors that affect the detection sensitivity of metabolites in the process from the sample pretreatment operation until the sample is introduced into the GC/MS and the analysis is completed. The detection sensitivity of metabolites is determined by the product of these factors.
(1) extraction efficiency in liquid-liquid extraction in a biological sample (plasma),
(2) reaction efficiency of the derivatization reaction to promote ionization,
(3) a ratio at which an object substance is not adsorbed in the mass spectrometer until ionization after being injected into the mass spectrometer,
(4) ionization efficiency,
(5) transmittance in the mass separation section of ions, and
(6) detection efficiency of the detector.

With regard to the factors (4) to (6), it is known from experience that when the GC/MS device is the same model (type), the relative measured value of each object substance does not change significantly even if each treatment condition at the pretreatment stage or in the analysis using the GC/MS changes. On the other hand, with regard to the factors (1) to (3), there is a case where the influence of a variation of each processing condition differs for each object substance, and as a result, the detection sensitivity differs for each object substance. Therefore, a condition that affects any one of the factors (1) to (3) was set, GC/MS analysis was performed on the same sample under different conditions, and the object substances were grouped based on the change rate in the measured values of the object substances obtained under different conditions.

Specifically, (1-1) the pH of the sample and (1-2) amount of matrix (lipid) in the sample were set as conditions that affect factor (1), (2-1) derivatization reaction time and (2-2) amount ratio of the derivatization reaction reagent to the sample were set as conditions that affect factor (2), and (3-1) the number of uses of an insert, (3-2) the number of uses of column, and (3-3) the number of uses of ion source were set as conditions that affect factor (3). Regarding (3-1) to (3-3), it is known that the adsorption amount decreases as the number of uses increases.

Then, for the biological sample (plasma), GC/MS analysis was performed with any one of the above conditions being changed, an area value was obtained from a peak derived from the object substance appearing in a chromatogram created from the obtained result, and cluster analysis was performed using a change rate in the area value before and after changing the condition as an index to group metabolites. Hereinafter, specific examples will be described.

### First Example

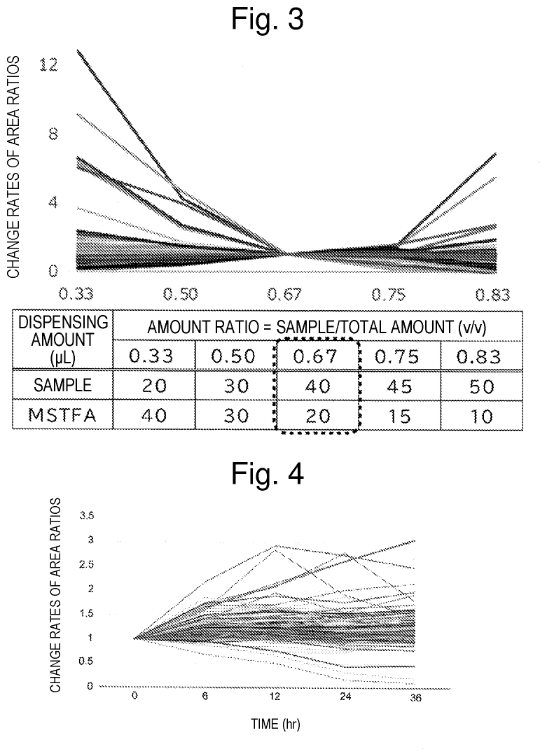

The upper row of FIG. 3 is a graph showing a change rate in the area value of each metabolite when GC/MS analysis is performed while, as the condition (2-2). changing an amount ratio of the derivatization reagent (trimethylsilyl (TMS) agent) to the sample (=sample/total amount (v/v)) to 0.33, 0.50, 0.67, 0.75, and 0.83 and the other conditions are the same. In this graph, the reference condition is a case where the amount ratio is 0.67, the area value in that case is 1, and the area values at the other amount ratios are shown. As shown in the lower table of FIG. 3, in this example, MSTFA (N-methyl-N-trimethylsilyltrifluoroacetamide) was used as a TMS conversion agent. In addition, a dispensed amount (μL) of the sample and the TMS conversion agent at each amount ratio is as shown in the lower table of FIG. 3. For example, a sample with an amount ratio of “0.33” (derivatized sample) was prepared by adding 40 μL of a TMS conversion agent to 20 μL of the sample (oximation sample).

### Grouping

As a result of performing cluster analysis using the area values shown in FIG. 3, the metabolites contained in the sample were divided into 10 clusters (groups) as shown in Table 1.

TABLE 1

| | |
|---|---|
| Number of | Average change rate |

| No | components | 0.33 | 0.50 | 0.75 | 0.83 |
|---|---|---|---|---|---|
| 1 | 4 | 1.28 | 1.09 | 0.85 | 0.84 |
| 2 | 64 | 0.94 | 0.98 | 0.97 | 0.94 |
| 3 | 1 | 0.73 | 0.85 | 0.87 | 1.01 |
| 4 | 10 | 1.11 | 1.12 | 0.74 | 0.23 |
| 5 | 9 | 0.63 | 0.94 | 0.91 | 0.14 |
| 6 | 1 | 1.98 | 1.44 | 0.78 | 0.84 |
| 7 | 1 | 0.15 | 0.56 | 1.08 | 0.04 |
| 8 | 1 | 0.99 | 0.99 | 0.99 | 2.63 |
| 9 | 1 | 1.39 | 1.48 | 0.40 | 0.01 |
| 10 | 1 | 6.60 | 2.67 | 0.59 | 0.42 |

A cluster having 1 component among 10 clusters shown in Table 1 (clusters of No. 3 and 6 to 10, hereinafter referred to as “Cluster 3” and the like) are outliers, so that no internal standard substance was selected.

On the other hand, Cluster 4 and Cluster 5 showed a tendency that an area value decreases when an amount ratio is large, that is, when a proportion of the sample is large. Therefore, internal standard substances were selected for Cluster 4 and Cluster 5. Note that amino acid is one of the components contained in plasma in a large amount. It is known that the derivatization efficiency of the amino acid is low, and it is estimated that the area value decreased as the amount ratio increased. It can be said that the results shown in Table 1 reflect such properties of amino acids.

### Selection of Internal Standard Substance

Among the components contained in each cluster, the component indicating a value closest to the median of change rates of area values is selected as an internal standard substance. The “component indicating a value closest to the median of change rates” can be, for example, a component indicating the median with a high frequency by determining a component indicating the median of the change rates at each amount ratio. In addition, for example, the square of a difference between the average change rate and the change rate of each component at each amount ratio is obtained, and the component having the minimum sum of the square values of the differences can be obtained. Whether the component indicating the median value of the change rate is used as an index or the sum of the square values of the differences is used as an index may be appropriately determined in consideration of the number of components included in the cluster, variations in the change rate, and the like.

When the sum of the square values of the difference between the mean change rate and change rates of the respective components was used as an index, valine and omithine were selected as candidates for the internal standard substance in Cluster 4 and Cluster 5, respectively.

### Verification Experiment

Next, in order to verify the validity of the internal standard substance selected by the above-described method, three kinds of plasma samples were analyzed using a GC/MS device owned by each facility in three different facilities, and metabolites contained in the plasma samples were measured. GC/MS analysis was performed four times for one kind of plasma sample at each facility. That is, as a result of performing a total of 12 times of GC/MS analysis on one kind of plasma sample, 12 pieces of analysis data were acquired. For the 12 pieces of analysis data, reproducibility (CV %) of the result of obtaining the area value (area ratio) of each metabolite was calculated using 2-isopropylmalic acid (2-IPMA) as a general internal standard substance and valine and ornithine as internal standard substances selected by the above-described method, the same calculation was performed for six kinds of plasma samples, and validity was evaluated based on the obtained average value. The results are shown in Tables 2 and 3.

TABLE 2

IS
CV %

| Metabolites | 2-IPMA | Valine |
|---|---|---|
| 2-Aminobutyric acid | 18.7 | 11.3 |
| Glutamic acid | 18.9 | 8.2 |
| 3-Indolepropionic acid | 18.0 | 6.9 |
| Tryptophan | 17.5 | 7.4 |
| Histidine | 12.0 | 23.7 |
| Cystine | 58.4 | 64.8 |
| Valine | 19.3 | — |
| Phenylalanine | 20.8 | 5.4 |
| Alanine | 28.7 | 14.6 |
| Isoleucine | 26.2 | 11.5 |

TABLE 3

IS
CV %

| Metabolites | 2-IPMA | Ortnithine |
|---|---|---|
| Lysine | 24.4 | 31.8 |
| Ornithine | 21.0 | — |
| Tyramine | 18.7 | 6.6 |
| 2-Aminoethanol | 29.1 | 10.4 |
| Glycine | 24.2 | 6.2 |
| Kynurenine | 76.7 | 79.7 |
| Indol-3-acetic acid | 18.6 | 10.0 |
| ParaXanthine | 55.9 | 46.3 |
| Asparagine | 65.8 | 68.7 |

For 8 of 10 components contained in Cluster 4 (including valine selected as an internal standard) and 6 of 9 components contained in Cluster 5, a value of reproducibility (CV %) was smaller and reproducibility was improved when valine or ornithine was used as an internal standard substance than when 2-IPMA was used as an internal standard substance.

On the other hand, a reproducibility of the area value of histidine, which is a component contained in Cluster 4, was significantly greater when valine was used than when 2-IPMA was used as an internal standard substance. It is known that the area value (area ratio) of histidine is greatly affected by the number of uses of an insert which is one of consumables of a GC/MS device, and it has been found that such a property of histidine is reflected in the results shown in Table 2.

### Second Example

FIG. 4 is a graph showing a change rate in the area value of each metabolite when subjected to GC/MS analysis with a derivatization reaction time of the condition (2-1) being changed to 0 hour, 6 hours, 12 hours, 24 hours, and 36 hours and the other conditions being the same. In this graph, the reference condition is a case where a reaction time is 0 hour, the area value in that case is 1, and the area values at the other reaction times are shown. In the present example, metabolites were derivatized using a TMS conversion agent.

### Grouping

As a result of performing cluster analysis using the area value of each metabolite shown in FIG. 4, the metabolites contained in the derivatized sample were divided into 11 clusters (groups) as shown in Table 4.

TABLE 4

| | |
|---|---|
| Number of | Average change rate |

| No | components | 6 hr | 12 hr | 24 hr | 36 hr |
|---|---|---|---|---|---|
| 1 | 1 | 0.86 | 0.84 | 0.78 | 0.84 |
| 2 | 13 | 1.04 | 1.02 | 0.95 | 1.01 |
| 3 | 19 | 1.07 | 1.13 | 1.09 | 1.16 |
| 4 | 20 | 1.15 | 1.14 | 1.12 | 1.18 |
| 5 | 2 | 1.15 | 1.29 | 1.36 | 1.43 |
| 6 | 23 | 1.20 | 1.23 | 1.19 | 1.22 |
| 7 | 5 | 1.30 | 1.27 | 1.17 | 1.16 |
| 8 | 2 | 0.78 | 0.59 | 0.25 | 0.14 |
| 9 | 6 | 1.42 | 1.48 | 1.49 | 1.56 |
| 10 | 2 | 1.55 | 1.61 | 1.33 | 1.39 |
| 11 | 2 | 1.64 | 2.13 | 2.62 | 3.06 |

Table 4 shows average values of the change rates of metabolites contained in each cluster.

Of the 11 clusters shown in Table 4, the components contained in each of the clusters having 1 or 2 components (No. 1, 5, 8, 10, 11) can be said to be outliers, and therefore no internal standard substance was selected. In addition, area values of the components contained in Cluster 2 and Cluster 3 did not change much even when the reaction time was changed. On the other hand, change rates of the components contained in Cluster 4 and Cluster 6 increased by about 10% when the reaction time was changed. In addition, a change rate of the components contained in Cluster 9 rapidly increased by changing the reaction time from 0 hour to 6 hours, but the change rate hardly changed even when the reaction time was further lengthened, and a stable component was contained. Therefore, in the present example, an internal standard substance was selected for Cluster 9.

### Selection and Verification Experiment of Internal Standard substance

Metabolites contained in Cluster 9 are shown in Table 5. As can be seen from Table 5, Cluster 9 contained sugars and lipids. Since it is difficult to separate sugars derivatized with a TMS conversion agent by GC/MS, an internal standard substance was selected in the same manner as in the first example, focusing only on lipids in this example. As a result, a margaric acid was selected as an internal standard substance. When a reproducibility (CV %) of the results of obtaining the area values of the six metabolites shown in Table 5 was calculated using 2-IPMA and margaric acid, the reproducibility of the five metabolites (including margaric acid) except for sucrose was improved.

TABLE 5

IS
CV %

| Metabolites | 2-IPMA | Margaric acid |
|---|---|---|
| Galactose | 41.2 | 36.9 |
| Margaric acid | 25.7 | — |
| Linoleic acid | 29.7 | 19.4 |
| Oleic acid | 22.3 | 21.1 |
| Sucrose | 22.0 | 23.5 |
| Cholesterol | 78.9 | 22.4 |

Note that in the first and the second examples described above, the change rate in the area value of each metabolite when one condition is changed was obtained, but it is also possible to determine the change rate in the area value of each metabolite by changing a plurality of conditions in combination, and group metabolites based on the change rate. For example, it is also possible to group metabolites by performing cluster analysis on a result of measuring a sample using GC/MS owned by each of a plurality of facilities, with a difference in facilities included in an index. In this case, as in the verification experiment performed in the first example described above, regarding the result obtained by measuring the sample using the GC/MS of three facilities, the area value of each metabolite obtained in one of the three facilities is set as the reference value, and the area value obtained in the other two facilities is divided by the reference value, and thus the change rate in the area value of each metabolite between the facilities can be calculated.

When an object substance contained in a biological sample is analyzed by GC/MS, pretreatment such as treatment for removing a substance which becomes an inhibiting factor of analysis from the biological sample and derivatization treatment for promoting ionization of the object substance is performed. A standard substance for correcting an influence of such pretreatment and an error in the amount of a sample used for analysis is added to the sample.

Usually, one kind of compound 2-IPMA which can be stably detected by GC/MS is used as a standard substance. In addition, for about 20 kinds of important components among metabolites contained in the object substance. a substance in which one or a plurality of carbon atoms, hydrogen atoms, or nitrogen atoms contained in the component are substituted with a stable isotope (stable isotope substance) is used as a standard substance.

In this method, the metabolite corrected with the stable isotope substance can be corrected regardless of the difference in reaction efficiency in the pretreatment or the derivatization reaction for promoting ionization. However, it is not realistic in terms of cost to add an expensive stable isotope substance so as to correspond to all the target components, and the throughput and sensitivity decrease since the number of components to be analyzed increases. Therefore, most components are corrected with one standard substance which can be stably detected, but there is a possibility that a substance having a chemical property different from that of the standard substance cannot be corrected well depending on the analysis.

### Aspect

It will be understood by those skilled in the art that the exemplary embodiments described above are specific examples of the following aspects.

### (Clause 1)

One aspect of the present invention is a multi-correction analysis method for correcting a result of analyzing a large number of compounds contained in a sample using a chromatograph, the method including: grouping at least a part of a large number of object substances which are possibly contained in a sample to be analyzed into a plurality of groups based on changes in the measured values of the part of the object substances obtained by performing chromatographic analysis of the sample a plurality of times under different analysis conditions, and determining a surrogate substance for each of the plurality of groups: and
adding the surrogate substances to the sample as internal standard substances common to the object substances contained in each group, and correcting a measured value of each of the large number of object substances obtained from a result of chromatographic analysis of the sample with a measured value of the internal standard substance corresponding to a group to which the object substance belongs.

### (Clause 2)

In the multi-correction analysis method using the chromatograph of Clause 1,
the analysis condition may be any one of pH of the sample, an amount of lipid in the sample, an amount of a chemical reaction reagent for promoting ionization, a chemical reaction time for promoting ionization, the number of uses of a sample injection container of a chromatograph analyzer, and the number uses of a separation column used for chromatographic analysis.

### (Clause 4)

In the multi-correction analysis method using the chromatograph of Clause 1,
the “performing chromatographic analysis of the sample a plurality of times under different analysis conditions” may be performing chromatographic analysis of the sample by each of a plurality of different types of devices.

In the multi-correction analysis method using the chromatograph of Clause 1, the “chromatograph” in the present invention is a gas chromatograph or a liquid chromatograph, and includes a chromatograph mass spectrometer which uses a mass spectrometer as a detector.

The phrase “a large number of” used in the previous description, as in “a large number of compounds” or “a large number of object substances”, is not intended to define any specific lower limit. However, it is ordinarily reasonable to consider that there should be at least ten compounds, and normally tens of compounds or even more, taking into account the number of compounds to be covered in a simultaneous multicomponent analysis under normal conditions.

In the multi-correction analysis method using the chromatograph according to Clause 1, a large number of object substances that are possibly contained in a sample to be analyzed are actually subjected to chromatographic analysis a plurality of times under different analysis conditions, and the object substances are grouped based on changes in a measured value of each object substance obtained by the chromatographic analysis a plurality of times. Therefore, even when a large number of object substances having similar chemical and physical properties are analyzed at one time using a chromatograph, the large number of object substances can be appropriately grouped, and correction can be performed in consideration of an influence of a recovery rate and a detection efficiency of the object substance in processes from sample preparation to chromatographic analysis.

Conventionally, it is difficult to overcome variations in measured values due to differences in facilities owning devices used for chromatographic analysis (differences between facilities) and variations in measured values due to column replacement or stopping of the devices even with the same device. In a case where a biological sample collected from a large number of subjects is chromatographically analyzed for marker search for a specific disease, it is necessary to continuously analyze all biological samples with one device. However, by the present method, it is possible to compare results of analysis with a plurality of devices or results of discontinuous measurement with the same device, and efficient marker search can be performed.

When the large number of object substances are appropriately grouped. as in the multi-correction analysis method using the chromatograph of Clause 2, if the analysis condition is any one of the pH of the sample, the amount of lipid in the sample, the amount of a chemical reaction reagent for promoting ionization, the chemical reaction time for promoting ionization, the number of uses of the sample injection container of the chromatograph analyzer, and the number uses of the separation column used for chromatographic analysis, the change rate of the measured value of each object substance obtained by chromatographic analysis performed under different analysis conditions reflects the influence of loss of a part of the object substance in the sample by a pretreatment operation of the sample such as a treatment for removing a substance that becomes an inhibitor of analysis from the sample, a derivatization treatment for promoting ionization of the object substance, or the like, and alternatively by adsorption of the object substance introduced into the chromatograph analyzing device in the sample injection container or the separation column. Therefore, it is possible to appropriately group a large number of object substances contained in a sample while reflecting such an influence, and it is possible to perform highly accurate analysis in which a variation in measured values due to such an influence is corrected.

In addition, in a case where performing chromatographic analysis of the sample a plurality of times under different analysis conditions is performing the chromatographic analysis of the sample by each of a plurality of different types of devices, as in the multi-correction analysis method using a chromatograph of Clause 4, it is possible to perform grouping in consideration of variations in the measured value of the object substance due to individual differences of the chromatographic analysis device without considering the analysis conditions as in Clause 2, and it is possible to perform accurate quantification in which such variations are corrected.

Here, the “plurality of different types of devices” are devices having different types of columns, devices having different detectors, devices of different models, devices of different manufacturing companies, devices of different years of use, and the like. In addition, a device owned by each of a plurality of different facilities may be referred to as “plurality of different types of devices”.

### (Clause 3)

In the multi-correction analysis method using the chromatograph of Clause 1, the surrogate substance may be a compound in which one of object substances contained in a group to which the surrogate substance is assigned is labeled with a stable isotope

In the multi-correction analysis method using the chromatograph of Clause 3, a compound having the same structure as one of the object substances contained in each group and slightly different in mass is used as the surrogate substance, and therefore, the measured value of the object substance contained in the group to which the surrogate substance is assigned can be appropriately corrected.

### (Clause 5)

In the multi-correction analysis method using the chromatograph of Clause 1, the chromatographic analysis may be gas chromatography mass spectrometry.

### (Clause 6)

In the multi-correction analysis method using the chromatograph of Clause 1, the sample may be a sample containing plasma.

In the case of a sample containing plasma, an object substance to be analyzed using a chromatograph is often a metabolite such as sugar, lipid, or protein. Many metabolites are usually similar in chemical properties and physical properties, and it is difficult to appropriately group them by the method as described in Patent Literature 2, but according to the multi-correction analysis method using the chromatograph of Clause 6, even such object substance can be appropriately grouped.

### REFERENCE SIGNS LIST

1 . . . Gas Chromatograph
10 . . . Sample Vaporization Chamber
11 . . . Micro-Syringe
12 . . . Column Oven
13 . . . Column
2 . . . Mass Spectrometer
20 . . . Analysis Chamber
21 . . . Ion Source
22 . . . Ion Lens
23 . . . Quadrupole Mass Filter
24 . . . Detector
3 . . . Data Processing Unit
30 . . . Data Storage Section
31 . . . Chromatogram Creator
32 . . . Peak Detector
33 . . . Peak Area Ratio Calculator
35 . . . Internal Standard Substance Database
4 . . . Analysis Control Unit
5 . . . Central Control Unit
6 . . . Input Unit
7 . . . Display Unit
8 . . . Simultaneous Multicomponent Analysis Control Program

1. A multi-correction analysis method for correcting a result of analyzing a large number of object substances contained in a sample using a chromatograph, the method comprising: grouping at least a part of a large number of object substances which are possibly contained in a sample to be analyzed into a plurality of groups based on changes in measured values of the part of object substances obtained by performing chromatographic analysis of the sample a plurality of times under different analysis conditions, and determining a surrogate substance for each of the plurality of groups; and adding the surrogate substance to the sample as an internal standard substance common to object substances contained in each group, and correcting a measured value of each of the large number of object substance obtained from a result of chromatographic analysis of the sample with a measured value of an internal standard substance corresponding to a group to which the object substance belongs.

2. The multi-correction analysis method using the chromatograph according to claim 1, wherein
the analysis condition is any one of pH of the sample, an amount of lipid in the sample, an amount of a chemical reaction reagent for promoting ionization, a chemical reaction time for promoting ionization, a number of uses of a sample injection container of a chromatograph analyzer, and a number of uses of a separation column used for chromatographic analysis is different.

3. The multi-correction analysis method using the chromatograph according to claim 1, wherein
the surrogate substance is a compound in which one of object substances contained in a group to which the surrogate substance is assigned is labeled with a stable isotope.

4. The multi-correction analysis method using the chromatograph according to claim 1, wherein
the performing chromatographic analysis of the sample a plurality of times under different analysis conditions is performing the chromatographic analysis of the sample by each of a plurality of different types of devices.

5. The multi-correction analysis method using the chromatograph according to claim 1, wherein
the chromatographic analysis is gas chromatography mass spectrometry.

6. A multi-correction analysis method using the chromatograph according to claim 1, wherein
the sample is a sample containing plasma.
